(19) United States
(12) Patent Application Publication
(10) Pub. No.: US 2015/0319672 A1
(43) Pub. Date: Nov. 5, 2015

(54) METHOD AND APPARATUS FOR CONTROLLING ASSOCIATION OF A STATION WITH A WLAN

(71) Applicant: TELEFONAKTIEBOLAGET L M ERICSSON (PUBL), Stockholm (SE)

(72) Inventors: Tomas Hedberg, STOCKHOLM (SE); Jari Tapio Vikberg, JÄRNA (SE); Oscar Zee, STOCKHOLM (SE)

(21) Appl. No.: 14/648,338

(22) PCT Filed: Nov. 29, 2012
(86) PCT No.: PCT/EP2012/073954

§ 371 Date: May 29, 2015

(51) Int. Cl. H04W 48/08; H04W 60/04; H04W 74/00

(52) U.S. Cl. CPC H04W 48/08; H04W 74/002; H04W 60/04; H04W 84/02

(57) ABSTRACT

The present invention controls the association of a station to a wireless local area network, WLAN. In particular it enables an entity in a WLAN to control when a station requests association with the WLAN to reduce the number of requests that the entity has to process. The method involves an entity of the WLAN transmitting a message including a condition which has to be fulfilled before the station can transmit a request to associate with the WLAN.

### TECHNICAL FIELD

The present invention relates to a method and apparatus for controlling the association between a station and a WLAN and more particularly, for controlling the association between a station and a WLAN access point.

### BACKGROUND

Data traffic in mobile telecommunications networks is continually increasing. Consequently, operators are employing heterogeneous access networks that utilise multiple radio access technologies (RATs) in order to provide greater capacity, particularly in high traffic areas and areas that otherwise have poor network coverage.

Typically, the radio access technologies utilised as part of these heterogeneous access networks include UMTS Radio Access Network (UTRAN) and an Evolved UTRAN (E-UTRAN), and Wi-Fi/WLAN. For example, FIG. 1 illustrates schematically a simplified example of a heterogeneous network 1 that comprises a 3GPP network 2 and a Wi-Fi RAN 3 suitable for implementing the methods described herein.

The 3GPP network 2 may include a 3GPP Radio Access Network (RAN) which includes a number of 3GPP radio nodes 4. For example, if the 3GPP RAN was a UTRAN, then these radio nodes would be NodeBs and Radio Network Controllers (RNC). By way of further example, if the 3GPP RAN was an E-UTRAN, then these radio nodes would be eNode Bs. The 3GPP RAN 2 is connected to a mobile core network 5.

The WLAN 3 includes a number of WLAN APs 7 that may be connected to a WLAN Access Controller (AC) 8. If present the WLAN AC 8 can control each of the WLAN APs 7 and assists in authentication of a mobile station/user terminal that wants to associate with/attach to the WLAN 3. Within the WLAN a single AP and any mobile stations/user terminals associated with it is called a basic service set (BSS). A BSS is identified using a basic service set identification (BSSID) which may be the AP's MAC address.

Interconnected BSSs and/or integrated WLANs may appear as a single BSS to the logical link control layer. The interconnected BSSs and/or integrated WLANs are called an extended service set (ESS) and have a common service set identifier (SSID). Both the BSSID and SSID can be used within messages to identify the part of the WLAN the message relates to or has been sent from.

If the heterogeneous access network comprises a UTRAN, an E-UTRAN, and a Wi-Fi RAN/WLAN then both the UTRAN and E-UTRAN standards are defined by the 3rd Generation Partnership Project (3GPP), and the relevant 3GPP standards therefore define capabilities for handling load sharing between these 3GPP RANs. In contrast, the Wi-Fi/WLAN standards are defined by the Institute of Electrical and Electronics Engineers (IEEE), and neither the IEEE standards nor the 3GPP standards define capabilities for handling load sharing between Wi-Fi/WLAN and the 3GPP RANs.

In particular, for most currently available devices, i.e. stations (STA) or a client device, when the device is within the coverage of both a Wi-Fi RAN/WLAN and a 3GPP network, the device will automatically attempt to connect to the Wi-Fi RAN/WLAN and may detach from the 3GPP RAN.

STAs always initiate the association process and a WLAN AP may choose to grant or deny the association based upon the contents of an association request. In a WLAN network operating according to the 802.11 standard (Wi-Fi) the WLAN AP will periodically transmit a Beacon frame which contains information about the WLAN including, for example, the SSID for the AP.

An example of a method of associating a STA and a Wi-Fi AP is illustrated in FIG. 2. As described above the Wi-Fi AP periodically transmits a Beacon frame. When a STA attempts to associate with the WLAN identified in the Beacon frame it will transmit a Probe Request requesting information from the Wi-Fi AP. An AP, upon receiving a probe request will reply with a Probe Response message including station parameters. The station parameters may include, for example, capability information and supported data rates.

In order to associate with the Wi-Fi AP the STA must be authenticated. The STA therefore transmits an Authentication Request to request authentication which may take place using any suitable authentication scheme. Once authentication has occurred the Wi-Fi AP transmits the STA an Authentication Response message and the STA upon receiving such a response message can send an Association Request message to the Wi-Fi AP. The Wi-Fi AP transmits a response to the Association Request indicating whether the association is accepted or rejected.

Optionally, where the WLAN is not open, further authentication is required over that described above. Where further authentication such as that defined in the EAP-SIM/AKA/AKA′ protocol, is required then the Authentication Request only opens limited ports to enable the further authorisation to take place. Full association is only granted upon successful completion of the further authentication.

An alternative standard which may govern communications between a WLAN AP and the STA is HotSpot 2.0. HotSpot 2.0 builds on IEEE 802.11u, and adds requirements on authentication mechanisms and auto-provisioning support. HotSpot 2.0 uses the Access network Query Protocol (ANQP) as illustrated in FIG. 3. In HotSpot 2.0 the ANQP provides a mechanism for the STA to request different information from the AP before association occurs.

At any point in the association procedures described above the WLAN AP may reject the access attempt. It is preferable to reject an association request from a STA as soon as possible in order to limit the resources that the WLAN AP and the rest of the network devotes to processing requests from the STA. However, as only a temporary or non-verified identifier, such as the MAC address associated with the device is known to the WLAN rather than a permanent identifier (such as the STA's IMSI) can be difficult to reject an association request early in the procedure. This results in an unnecessary load on the WLAN AP and the rest of the network in terms of air interface signalling and also processing capacity.

Additionally, some STAs will continuously try to re-associate and re-authenticate to the same WLAN AP even if the WLAN AP has previously rejected an association attempt by the STA, for example, by rejecting authorization. This will increase the load on the WLAN AP even further.

### SUMMARY

In accordance with an aspect of the invention there is provided a method of operating an entity in a wireless local area network, WLAN. In the method a message including a condition to be fulfilled by a device before the device may transmit a request to associate with a WLAN AP is transmitted to the device. This allows a WLAN or WLAN AP to shape an STAs behaviour when it determines to attach to a WLAN. It may be of use, for example, where a particular WLAN AP has a high load but another WLAN AP having overlapping coverage has a lower load and is therefore better able to service a device.

The condition may be determined using one or more of: a parameter associated with the WLAN, a parameter associated with the device or a parameter associated with a 3^{rd} Generation Partnership Project, 3GPP, network having one or more cells overlapping with the coverage area of the WLAN. This allows the shaping of the STAs behaviour to be appropriate to the network conditions at the point when the STA is to attach to a WLAN AP.

The condition may be a received signal strength indicator, RSSI, value. This RSSI value may be one or more of a minimum RSSI strength; a minimum basic service set, BSS, RSSI value and a relative RSSI value.

Alternatively or additionally the device may be transmitted a message including a load value as the condition. The load value may be one or more of: BSS Load or WAN Metrics.

The condition may be associated with a SSID or a BSSID associated with the WLAN.

The condition may specify that the device can request attachment if no BSS with a lower load is available or if no BSS having a lower load and supporting the PLMN the device is attached to is available. This is of particular use where a WLAN AP has a relatively high load and would be able to service the STA but another WLAN AP with a lower load may be available. By using such a condition load sharing between WLAN APs is promoted.

The message may be a broadcast message or a device specific message.

In accordance with another aspect of the present invention there is provided an entity in a wireless local area network, WLAN. The entity includes a transmitter which is able to transmit a message including at least one condition and an indication that the condition is to be fulfilled by a device before transmitting a request to associate with a WLAN AP.

In accordance with a further aspect of the present invention there is provided a device. The device includes a receiver and a processor. The receiver receives a message from an entity in a wireless local area network, WLAN, the message including at least one condition and an indication that the condition is to be fulfilled by a device before transmitting a request to associate with a WLAN. The processor is able to determine whether the condition has been met and if the condition has not been met preventing the device transmitting a request for association with the WLAN.

The condition may be any one or more of a value of a received signal strength indication, RSSI, and the processor, in determining whether the condition has been met, determines whether the RSSI at the device is greater than the RSSI value in the indication and, preventing the apparatus from attempting connection to the WLAN if the measured RSSI is less than the minimum RSSI.

A condition including an RSSI value in the message comprises one or more of: a minimum RSSI strength; a minimum basic service set, BSS, RSSI value and a relative RSSI value.

If the condition is a time interval then the processor, in determining whether the condition has been met, will determine whether the time interval has lapsed.

If the condition is a load value then the processor will prevent the apparatus from connecting to the WLAN when the load on the network is more than the load value.

The device may determine the load on the network using one or more of: a load value measured by the device, a BSS load or a WLAN Metrics element.

The condition may be that no BSS with a better RSSI value or lower load value is found or that no BSS supporting an identified PLMN with a better RSSI value or load value is found.

The condition may be related to an SSID or BSSID of a WLAN AP.

According to yet another aspect of the invention there is provided a method of operating a device. The method includes receiving a message from an entity in a wireless local area network, WLAN, the message including at least one condition and an indication that the condition is to be fulfilled by a device before transmitting a request to associate with the WLAN. The method also includes, upon receiving such a message, determining whether the condition has been met and if the condition has not been met preventing the device transmitting a request for association with the WLAN.

### BRIEF DESCRIPTION OF THE DRAWINGS

Some embodiments of the present invention will now be described in detail with reference to the accompanying drawings, in which:

FIG. 1 illustrates schematically an example of a heterogeneous access network;

FIG. 2 is a signalling flow diagram illustrating an example of a procedure for associating a STA with a Wi-Fi AP;

FIG. 3 is a signalling flow diagram illustrating an example of an alternative procedure for associating a STA with a Wi-Fi AP;

FIG. 4 is a schematic flow diagram illustrating a procedure of controlling an STA in accordance with the methods described herein;

FIG. 5 illustrates schematically an embodiment of a WLAN entity configured to implement the methods described herein; and

FIG. 6 is a flow diagram illustrating the procedure for associating a STA with a Wi-Fi AP in accordance with the methods described herein.

### DETAILED DESCRIPTION

The present invention relates to a message which is transmitted by a wireless local area network, WLAN to one or more stations (STAs). The message includes an instruction to an STA to enable the STA to determine when it may request an association with the WLAN. The message may be transmitted by a WLAN Access Point, AP, to all STAs within communication range such as a Beacon message. Alternatively, the message may be sent to a particular STA, for example as a result of a disassociation of the STA from the WLAN AP, a deauthentication of the STA or a determination by the WLAN not to allow association of the STA.

If the message is a generic message transmitted by the WLAN to any STA within its transmission range the instructions may indicate a minimum received signal strength indication (RSSI) that the STA is to achieve with a WLAN AP before the STA can request association with the WLAN; a maximum load value; or an indication that the STA may request an association with the WLAN if no better BSS is found or if no better BSS supporting a PLMN the STA is attached to is found.

If the message is transmitted to a particular STA by a WLAN AP the instruction may indicate a minimum received signal strength indication (RSSI) that the STA is to achieve with a WLAN AP before the STA can request association with the WLAN; a relative RSSI value; a time value indicating the amount of time before the STA may request association with the WLAN; a maximum load value; or an indication that the STA may request an association with the WLAN if no better BSS is found or if no better BSS supporting a PLMN the STA is attached to is found.

What is meant by a relative RSSI value is a value that indicates the difference between the current RSSI between a WLAN AP and the STA and the RSSI required for the STA to request association with the WLAN AP.

Each of these indications will now be discussed in more detail with reference to a WLAN AP and an STA.

1. Received Signal Strength Indication (RSSI)

As discussed above, the message may include a minimum RSSI value to be achieved by the STA before it can attempt association with a WLAN AP. The indication of the minimum RSSI value may be sent to the STA either in a generic message such as the 802.11 Beacon message or a specific message for the STA such as the 802.11 Probe Response message or in ANQP signalling.

The RSSI value may be a predetermined value stored in the memory of the WLAN AP. Alternatively, the WLAN AP may calculate a minimum RSSI value dependent upon one or more parameters. The parameters may include the RSSI in a message received from the STA, whether the STA requested disassociation from the WLAN AP, whether the STA was deauthenticated, the cell load of the WLAN AP or the load in one or more 3GPP cells having overlapping or neighbouring coverage to the coverage area of the WLAN AP. The WLAN may obtain details of the load of neighbouring 3GPP cells using the method described in PCT/EP2012/065970.

The RSSI value may be determined as described above by the WLAN AP or by a WLAN Access Controller, AC, which the WLAN AP is in communication with. The WLAN AC may use the same parameters as those described above to determine an RSSI value. Where the WLAN AC calculates the RSSI value the WLAN AC will transmit the RSSI value to one or more WLAN APs. The WLAN AP will then include the RSSI value received from the WLAN AC in a message to an STA. The WLAN AP may optionally store the RSSI value in a memory and retrieve the value when generating a message to transmit to the STA. The WLAN AC may be configured to transmit the RSSI value to one or more WLAN APs at predetermined time intervals or in response to a request for the RSSI value from a WLAN AP.

An STA upon receiving a message from a WLAN AP including a minimum RSSI value will monitor the RSSI of messages transmitted by the WLAN AP. If the RSSI of a message is greater than the minimum RSSI included in the indicator then the STA may attempt to associate with the WLAN AP again, for example by transmitting a Probe Request message to the WLAN AP.

2. Relative Received Signal Strength Indication (RSSI)

As discussed above, the message may include a relative RSSI value to be achieved by the STA before it can attempt association with a WLAN AP following an attempt by the STA to associate with the WLAN AP. What is meant by a relative RSSI value is a value that indicates the difference between the current RSSI and the RSSI required for the STA to request association with the WLAN AP.

The relative RSSI value is sent to the STA in a specific message for the STA such as an 802.11 Disassociation frame or an 802.11 Deauthentication frame. Alternatively the relative RSSI value may be transmitted in any EAP or DHCP response.

The relative RSSI value may be calculated by the WLAN AP using an RSSI value stored in the memory of the WLAN AP and a measured RSSI value for a message received from the STA. The WLAN AP may use the first message received from an STA, the last message received from an STA or a predetermined message type to determine the current RSSI value from the STA. For example, the message may be a Probe Request message.

The RSSI value may be a predetermined value stored in the memory of the WLAN AP. Alternatively, the WLAN AP may calculate a minimum RSSI value dependent upon one or more parameters. The parameters may include the RSSI in a message received from the STA, whether the STA requested disassociation from the WLAN AP, whether the STA was deauthenticated, the cell load of the WLAN AP or the load in one or more 3GPP cells having overlapping or neighbouring coverage to the coverage area of the WLAN AP. The WLAN may obtain details of the load of neighbouring 3GPP cells using the method described in PCT/EP2012/065970.

The RSSI value may be determined as described above by the WLAN AP or by a WLAN Access Controller, AC, which the WLAN AP is in communication with. The WLAN AC may use the same parameters as those described above to determine an RSSI value. Where the WLAN AC calculates the RSSI value the WLAN AC will transmit the RSSI value to one or more WLAN APs. The WLAN AP will then include the RSSI value received from the WLAN AC in a message to an STA. The WLAN AP may optionally store the RSSI value in a memory and retrieve the value when generating a message to transmit to the STA. The WLAN AC may be configured to transmit the RSSI value to one or more WLAN APs at predetermined time intervals or in response to a request for the RSSI value from a WLAN AP.

An STA upon receiving a message from a WLAN AP including a relative RSSI value will monitor the RSSI of messages transmitted by the WLAN AP. If the RSSI of a message is greater than the measured RSSI included in the indicator then the STA may attempt to associate with the WLAN AP again, for example by transmitting a Probe Request message to the WLAN AP.

Alternatively, the STA may, upon receiving a relative RSSI value determine a minimum RSSI value using the known RSSI of the message including the relative RSSI value and the relative RSSI value. This minimum RSSI value may be stored in a memory and compared to the RSSI of messages received from the WLAN AP.

3. Timer

The WLAN AP may include in a message to an STA a Retry Timer value. The value is counted down by the STA and when it reaches 0 the STA may attempt to associate with the WLAN AP again. The Retry timer is preferably sent to the STA in a specific message for the STA such as an 802.11 Disassociation frame or an 802.11 Deauthentication frame. The message may also be included in an EAP or a DHCP response.

The Retry Timer duration is preferably less than a minute but may be any suitable duration.

The Retry Timer value may be a predetermined value stored in the memory of the WLAN AP. Alternatively, the WLAN AP may calculate the Retry Timer value dependent upon one or more parameters. The parameters may include whether the STA requested disassociation from the WLAN AP, whether the STA was deauthenticated, the cell load of the WLAN AP or the load in one or more overlapping or neighbouring 3GPP cells. The WLAN may obtain details of the load of neighbouring 3GPP cells using the method described in PCT/EP2012/065970.

The Retry Timer value may be determined as described above by the WLAN AP or by a WLAN AC to which the WLAN AP is connected. Where the WLAN AC calculates the Retry Timer value and transmits it to the WLAN AP. The WLAN AP will then include the Retry Timer value received from the WLAN AC in the message to the STA.

The Retry Timer value may be determined as described above by the WLAN AP or by a WLAN Access Controller, AC, which the WLAN AP is in communication with. The WLAN AC may use the same parameters as those described above to determine the Retry Timer value. Where the WLAN AC calculates the Retry Timer value the WLAN AC will transmit the Retry Timer value to one or more WLAN APs. The WLAN AP will then include the Retry Timer value received from the WLAN AC in a message to an STA. The WLAN AP may optionally store the Retry Timer value in a memory and retrieve the value when generating a message to transmit to the STA. The WLAN AC may be configured to transmit the Retry Timer value to one or more WLAN APs at predetermined time intervals or in response to a request for the Retry Timer value from a WLAN AP.

An STA upon receiving a message from a WLAN AP including a Retry Timer will start a counter and when the value of the Retry Timer reaches a predefined value (for example 0) then the STA may attempt to associate with the WLAN AP again, for example by transmitting a Probe Request message to the WLAN AP.

The Retry Timer may also be included in a generic message such as an 802.11 Beacon frame. Where an STA receives a generic message including the Retry Timer will count down the Retry Timer prior to requesting association with the WLAN AP. For example, if the retry timer is contained within a Beacon frame the STA may count down the retry timer in the first Beacon frame that is received from a WLAN AP. This may be of use, for example, where the load on the WLAN AP is very high.

4. Load

The WLAN AP may include in a message to an STA a maximum load value. The load value may be sent to the STA either in a generic message such as the 802.11 Beacon message or a specific message for the STA such as the 802.11 Probe Response message or in ANQP signalling.

The load value may be a predetermined value stored in the memory of the WLAN AP. Alternatively, the WLAN AP may calculate a load value dependent upon one or more parameters. The parameters may the load on the WLAN, the load on the WLAN AP, the load on a 3GPP network including a cell which overlaps in coverage with the WLAN, the load on a cell in a 3GPP network which overlaps in coverage with a WLAN ESS, the load on a cell in a 3GPP network which overlaps in coverage with a WLAN, whether the device has been deauthenticated by the WLAN, whether the device has requested disassociation with the WLAN, and whether an association between the device and the WLAN has been denied during the association procedure. The WLAN may obtain details of the load of neighbouring 3GPP cells using the method described in PCT/EP2012/065970.

The load value may be determined as described above by the WLAN AP or by a WLAN Access Controller, AC, which the WLAN AP is in communication with. The WLAN AC may use the same parameters as those described above to determine the Retry Timer value. Where the WLAN AC calculates the load value the WLAN AC will transmit the load value to one or more WLAN APs. The WLAN AP will then include the load value received from the WLAN AC in a message to an STA. The WLAN AP may optionally store the load value in a memory and retrieve the value when generating a message to transmit to the STA. The WLAN AC may be configured to transmit the load value to one or more WLAN APs at predetermined time intervals or in response to a request for the load value from a WLAN AP.

An STA upon receiving a message from a WLAN AP including a maximum load value will monitor the load on the network. The STA may monitor the load on the network using any suitable method, for example, using the BSS Load parameter found in 802.11 Beacon frames, the WAN Metrics element in ANQP messages or by calculating itself the load on the radio interface. When the maximum load value is greater than the load determined by the STA then the STA may attempt to associate with the WLAN AP again, for example by transmitting a Probe Request message to the WLAN AP.

5. Misc Others

The message may, alternatively, include an indicator that the STA may request association with the WLAN AP if there is no BSS with a lower load and/or a greater RSSI. This will mean that the STA is directed to attempt association with the “best” WLAN AP. The BSS may be limited to those supporting the PLMN to which the STA is attached to i.e. is connected to or is camping on.

The minimum RSSI value or relative RSSI value may be linked to a particular BSSID or an SSID so that it applies to any WLAN AP transmitting messages with that BSSID or SSID

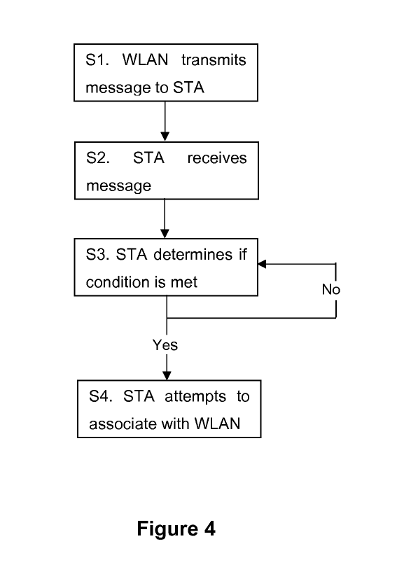

FIG. 4 is a flow diagram illustrating an example of the procedure implemented by an entity of a WLAN. The steps performed are as follows:

S1. The WLAN entity transmits a message to an STA. The message including one or more conditions as described above. The message may be a generic message to be received by any STA within transmission range of the entity or alternatively may be sent to a specific STA.

S2. The STA receives the message and processes the message.

S3. The STA will determine whether the condition or conditions contained within the message have been fulfilled. If the conditions have been fulfilled then the STA proceeds to step S4. If the conditions have not been fulfilled then the STA will wait a predetermined amount of time before repeating step S3.

S4. The STA will attempt to associate with the WLAN entity using any suitable method.

The condition transmitted in the message to the STA may be calculated in any suitable way. For example, it may be determined using one or more of a parameter associated with the WLAN, a parameter associated with the device or a parameter associated with a 3^{rd} Generation Partnership Project, 3GPP, network having one or more cells overlapping with the coverage area of the WLAN. The parameters may include the RSSI in a message received from the STA, whether the STA requested disassociation from the WLAN AP, whether the STA was deauthenticated, whether an association between the device and the WLAN has been denied during the association procedure, the load on the WLAN, the load on the WLAN AP, the load in one or more 3GPP cells having overlapping or neighbouring coverage to the coverage area of the WLAN AP, or the load on a 3GPP network having one or more cells with overlapping coverage to the coverage area of the WLAN AP. The WLAN may obtain details of the load of neighbouring 3GPP cells using the method described in PCT/EP2012/065970.

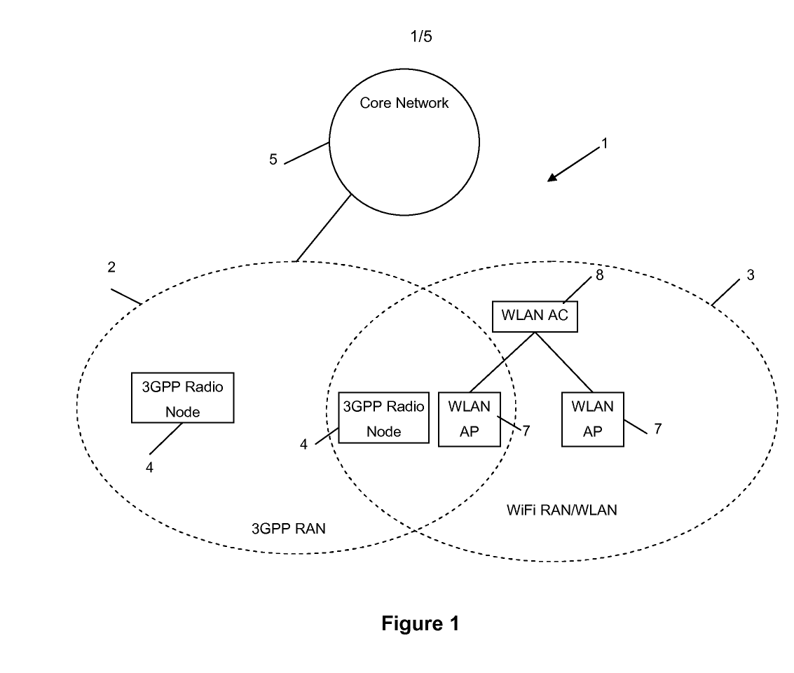

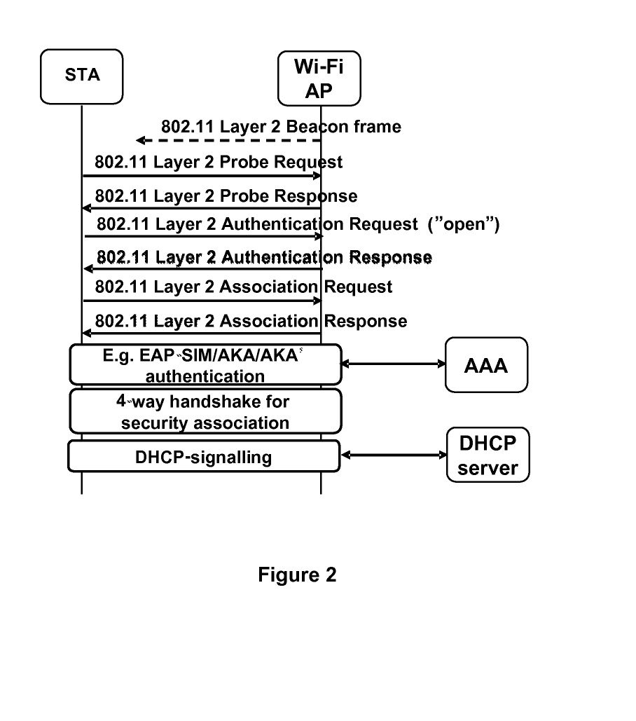

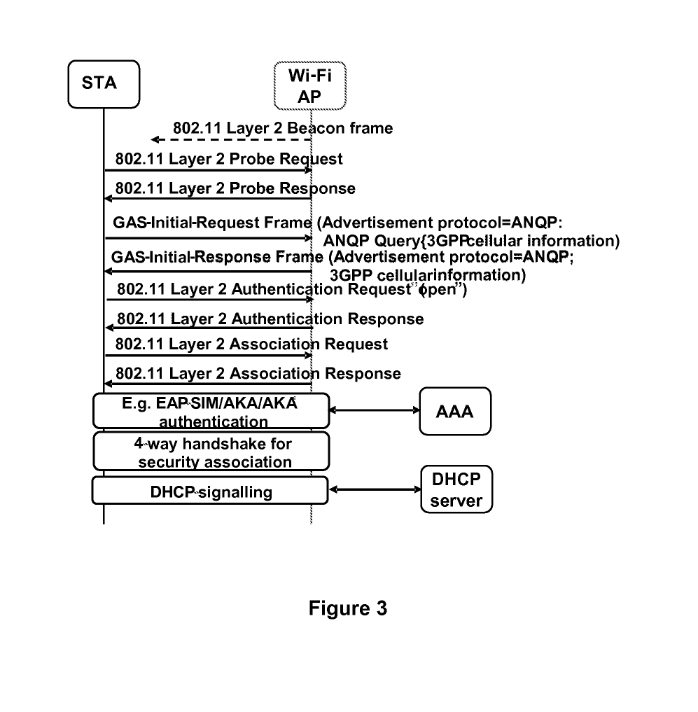

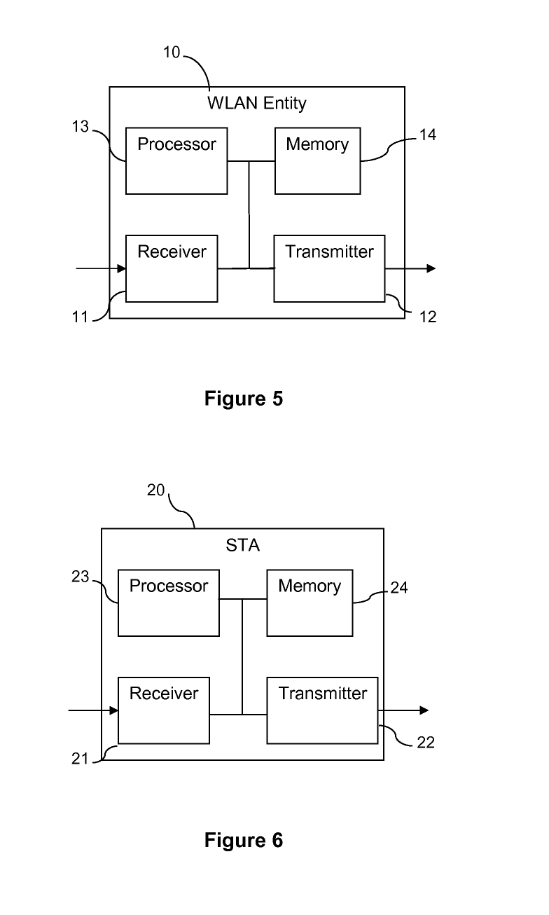

FIG. 5 illustrates schematically an embodiment of an entity of a WLAN 10 such as a WLAN AP configured to implement the methods described above. The WLAN entity 10 can be implemented as a combination of computer hardware and software and comprises a receiver 11, a transmitter 12, a processor 13, and a memory 14. The memory 14 stores the various programs/executable files that are implemented by the processor 13, and also provides a storage unit for any required data. For example, the memory 14 can store one or more conditions to be included in a message to an STA. The programs/executable files stored in the memory 14, and implemented by the processor 13, include but are not limited to a load and/or performance monitoring and reporting unit that implement the methods described above. The WLAN network may, optionally, be connected to the core network illustrated in FIG. 1.

FIG. 6 illustrates schematically an embodiment of an STA 20 configured to implement the methods described above. The STA 20 can be implemented as a combination of computer hardware and software and comprises a receiver 21, a transmitter 22, a processor 23, and a memory 24. The memory 24 stores the various programs/executable files that are implemented by the processor 23, and also provides a storage unit for any required data. For example, the memory 24 can store a condition to be met before the STA can request association with a WLAN. The programs/executable files stored in the memory 24, and implemented by the processor 23, include but are not limited to determining whether the condition stored in the memory 24 has been met. The STA may be, for example, a user equipment (UE), a mobile telephone, a tablet computing device or a laptop.

An STA may store the received condition in the memory until the condition is met. Alternatively, the STA may replace a condition stored in a memory with another condition upon receipt of a subsequent message from the WLAN AP or WLAN. The message may include an indication that the condition included in the message is to replace any earlier conditions relating to the WLAN AP or the WLAN. The message may, alternatively, include an indication that the condition is to be used in combination with any earlier conditions relating to the WLAN AP or the WLAN. The STA may further be configured to discard a condition if it has not received a message from the WLAN AP or WLAN within a predetermined period of time. This means, for example, that the STA does not retain conditions relating to a WLAN AP or WLAN when it has exited the coverage area for that WLAN AP or WLAN.

The STA may determine to transmit a request to a WLAN AP based on any one or any combination of the aforementioned conditions.

The STA may check whether the condition has been met at any suitable frequency. Preferably it will check the condition multiple times within a second.

The message including the indication may be from any suitable protocol. For example it may be sent using any one of 802.11 protocol, EAP protocol or DHCP protocols.

Although the present invention has been described with reference to the IEEE 802.11 and Wi-Fi Alliance standard specifications, the skilled person will understand how the methods described above may be applied to any Standard used to govern a WLAN and WLAN APs.

By 3GPP RAN or network what is meant is any RAN or network which is governed by 3GPP Standards. For example, a 3GPP network may be a UTRAN, an E-UTRAN or a Long Term Evolution (LTE) network. WLAN may refer to any wireless local area network including, but not limited to a Wi-Fi RAN.

Although the invention has been described in terms of preferred embodiments as set forth above, it should be understood that these embodiments are illustrative only. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein. In addition, whilst the above described embodiments specifically relate to heterogeneous networks comprised of at least a 3GPP RAN and a WLAN, the principles of the methods described herein are equally applicable to heterogeneous networks that comprise other radio access technologies; such as Global System for Mobile Communications (GSM), cdmaOne and CDMA2000.

1. A method of operating an entity in a wireless local area network, WLAN, comprising transmitting a message including a condition to be fulfilled by a device before the device may transmit a request to associate with a WLAN AP.

2. A method of operating an entity in a WLAN as claimed in claim 1 wherein the condition is determined using one or more of: a parameter associated with the WLAN, a parameter associated with the device or a parameter associated with a 3^{rd} Generation Partnership Project, 3GPP, network having one or more cells overlapping with the coverage area of the WLAN.

3. A method of operating an entity in a WLAN as claimed in claim 1 or claim 2 wherein the condition comprises a received signal strength indicator, RSSI, value.

4. A method of operating an entity in a WLAN as claimed in claim 3 wherein the RSSI value comprises one or more of: a minimum RSSI strength; a minimum basic service set, BSS, RSSI value and a relative RSSI value.

5. A method of operating an entity in WLAN as claimed in any one of the preceding claims wherein the condition comprises a load value.

6. A method of operating an entity in a WLAN as claimed in claim 5 wherein the load value comprises one or more of: BSS Load or WAN Metrics.

7. A method of operating an entity in a WLAN as claimed in any one of the preceding claims wherein the condition is associated with a SSID or a BSSID associated with the WLAN.

8. A method of operating an entity in a WLAN as claimed in claim 7 wherein the condition comprises determining whether a BSS with a lower load is available, if no BSS having a lower load and supporting the PLMN the device is attached to is available.

9. A method of operating an entity in a WLAN as claimed in any one of the preceding claims wherein the message is a broadcast message.

10. A method of operating an entity in a WLAN as claimed in any one of claims 1 to 8 wherein the message is a device specific message.

11. An entity in a wireless local area network, WLAN, comprising a transmitter configured to transmit a message, the message including at least one condition and an indication that the condition is to be fulfilled by a device before transmitting a request to associate with a WLAN AP.

12. A device comprising:
a receiver configured to receive a message from an entity in a wireless local area network, WLAN, the message including at least one condition and an indication that the condition is to be fulfilled by a device before transmitting a request to associate with a WLAN; and
a processor configured to determine whether the condition has been met and if the condition has not been met preventing the device transmitting a request for association with the WLAN.

13. A device as claimed in claim 12 wherein:
the condition comprises a value of a received signal strength indication, RSSI, and the processor, in determining whether the condition has been met, determines whether the RSSI at the device is greater than the RSSI value in the indication and, preventing the apparatus from attempting connection to the WLAN if the measured RSSI is less than the minimum RSSI.

14. A device as claimed in claim 13 wherein the RSSI value comprises one or more of: a minimum RSSI strength; a minimum basic service set, BSS, RSSI value and a relative RSSI value.

15. A device as claimed in any one of claims 12 to 14 wherein:
the condition comprises a time interval and the processor, in determining whether the condition has been met, determines whether the time interval has lapsed.

16. A device as claimed in any one of claims 12 to 15 wherein the condition comprises a load value and the processor is configured to prevent the apparatus from connecting to the WLAN when the load on the network is more than the load value.

17. A device as claimed in claim 16 wherein the device is configured to determine the load on the network using one or more of: a load value measured by the device, a BSS load or a WLAN Metrics element.

18. A device as claimed in any one of claims 10 to 15 wherein the condition comprises that no BSS with a better RSSI value or lower load value is found.

19. A device as claimed in claims 10 to 15 wherein the condition comprises that no BSS supporting an identified PLMN with a better RSSI value or load value is found.

20. A device as claimed in any one of the claims 13 to 19 wherein the value is dependent on the SSID or BSSID of the WLAN AP.

21. A method of operating a device comprising: upon receiving a message from an entity in a wireless local area network, WLAN, the message including at least one condition and an indication that the condition is to be fulfilled by a device before transmitting a request to associate with the WLAN, determining whether the condition has been met and if the condition has not been met preventing the device transmitting a request for association with the WLAN.
